(19) United States
(12) Patent Application Publication
(10) Pub. No.: US 2010/0070896 A1
(43) Pub. Date: Mar. 18, 2010

(54) Symbol Based Graphic Communication System

(75) Inventor: Billy Attinger, San Diego, CA (US)

Correspondence Address: Alvin Fashu-Kanu, 2959 Cowley Way Suite 96, San Diego, CA, 92117, US

(73) Assignee: SYMB , INC, San Diego, CA (US)

(21) Appl. No.: 12/549,334

(22) Filed: Aug. 27, 2009

Related U.S. Application Data
(60) Provisional application No. 61/092,335, filed on Aug. 27, 2008.

(51) Int. Cl. G06F 3/048; G06F 15/16; G06F 17/20

(52) U.S. Cl. 715/765; 715/810; 709/206; 704/8; 704/10

(57) ABSTRACT

Methods, apparatuses, and systems for communicating in a symbol based graphic language are described. In one embodiment, a symbol communication system includes a symbol communication server, a user interface module and a symbol module. The symbol communication server is associated with a communication network and is configured to support the symbol communication language. The user interface module is supported by the symbol communication server. Also the user interface module can be utilized for initiating an action associated with one or more symbol parameters, where the one or more symbol parameters constitute at least a portion of the symbol communication language. The symbol module is associated with the symbol communication server and is configured to process information relating to the one or more symbol parameters according to the initiated action.

### RELATED APPLICATION

This application claims the benefit of U.S. Provisional Patent Applications Ser. No. 61/092,335, filed Aug. 27, 2008, entitled “Symbol Based Graphic Communication System” which is hereby incorporated by reference in its entirety.

### FIELD OF THE INVENTION

The present invention generally relates to the field of communication technology and more particularly relates to symbol based graphic communication.

### BACKGROUND

With the popularity and rise in real-time text-based communications, such as instant messaging, e-mail, Internet and online gaming services, chat rooms, discussion boards and mobile phone text messaging (SMS), came the emergence of a new language tailored to the immediacy and compactness of these new communication media.

While it does seem amazing that there are more than 1,000 text messaging abbreviations, it is important to remember that different chat abbreviations are used by different groups of people when communicating online. Some of the following chat abbreviations may be familiar to you, while others may be foreign because they are used by a group of people with different online interests and hobbies than your own. For example, people playing online games are likely to use chat abbreviations that are different than those used by teenagers' texting on their cell phone or abbreviations used by someone updating a financial blog.

However, these text based messages are boring, static words. Accordingly there is a need for symbol based communication language that can be used to replace boring, static words in text with visually engaging function filled symbols.

### SUMMARY

The present invention includes methods, apparatuses, and systems as described in the written description and claims. In one embodiment, a symbol based graphic communication system (hereinafter system) for communicating in a symbol communication language is described. The system includes a symbol communication server, a user interface module and a symbol module. The symbol communication server is associated with a communication network and is configured to support the symbol communication language. The user interface module is supported by the symbol communication server. Also the user interface module can be utilized for initiating an action associated with one or more symbol parameters, where the one or more symbol parameters constitute at least a portion of the symbol communication language. The symbol module is associated with the symbol communication server and is configured to process information relating to the one or more symbol parameters according to the initiated action.

In another embodiment a user device for communicating in a symbol communication language is described. The user device includes a user device interface, a processor module and a communication module. The user device interface initiates an action associated with one or more symbol parameters where the one or more symbol parameters constitute at least a portion of the symbol communication language. The processor module is configured to process information relating to the one or more symbol parameters according to the initiated action. The communication module is configured to communicate over the communication network (hereinafter network) to a symbol communication language enabled device.

In other embodiments a method for communicating in a symbol based graphic communication system is described. The method includes initiating an action associated with one or more symbol parameters on a user interface module. The user interface module is associated with a computer processor and the computer processor is associated with a communication network. The one or more symbol parameters constitute at least a portion of the symbol communication language. The method also includes processing information related to the one or more symbol parameters by the symbol communication module associated with the computer processor according to the initiated action.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a network diagram illustrating an example system for symbol communication according to an embodiment;

FIG. 2 is a block diagram illustrating an example symbol communication server according to an embodiment;

FIG. 3 is a block diagram illustrating an example web server illustrated in FIG. 1 above according to an embodiment;

FIG. 4 is a block diagram illustrating an example symbol control module according to an embodiment;

FIG. 5 is a block diagram illustrating an example client or user device according to an embodiment;

FIG. 6 illustrates an example symbol data structure according to an embodiment;

FIG. 7 is a flowchart of an example method for processing symbol based graphic communication according to an embodiment;

FIG. 8 illustrates an example messaging interface according to an embodiment;

FIG. 9 is a screen shot of an example user interface illustrating a symbol library menu according to an embodiment;

FIG. 10 is a screen shot of an example user interface illustrating a menu of locations or places frequented by the user according to an embodiment;

FIG. 11 is a screen shot of an example user interface illustrating a messaging interface according to an embodiment;

FIG. 12 is a screen shot of another example messaging interface according to an embodiment;

FIG. 13 is a screen shot of another example messaging interface including a send option according to an embodiment;

FIG. 14 is a screen shot of another example messaging interface drag and drop function according to an embodiment;

FIG. 15 is a screen shot of an example user interface illustrating a functionality menu according to an embodiment;

FIG. 16 is a screen shot of an example user interface illustrating search functionality according to an embodiment;

FIG. 17 is a screen shot of an example user interface displaying a symbol search response according to an embodiment;

FIG. 18 is an example of a method for communicating in a symbol based communication system in accordance with an embodiment;

FIG. 19 is a block diagram illustrating an example wireless communication device that may be used in connection with various embodiments described herein; and

FIG. 20 is a block diagram illustrating an example computer system that may be used in connection with various embodiments described herein.

### DETAILED DESCRIPTION

Certain embodiments as disclosed herein provide for systems and methods for communicating in a symbol based graphic language or symbol communication language.

After reading this description it will become apparent to one skilled in the art how to implement the invention in various alternative embodiments and alternative applications. However, although various embodiments will be described herein, it is understood that these embodiments are presented by way of example only, and not limitation. As such, this detailed description of various alternative embodiments should not be construed to limit the scope or breadth of the present invention as set forth in the appended claims.

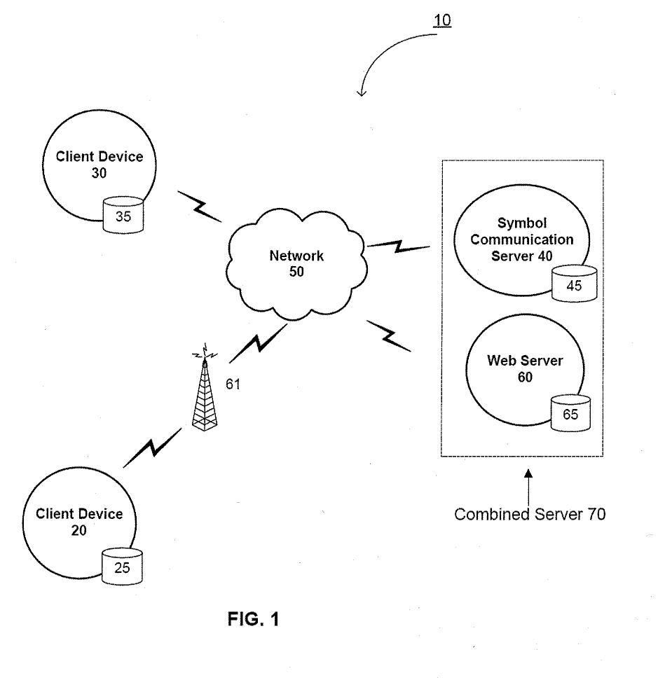

FIG. 1 is a network diagram illustrating an example system 10 for symbol communication (or symbol based graphic communication system) according to an embodiment. In the illustrated embodiment, the system 10 comprises a combined server 70 that is communicatively coupled with client or user device 20 and/or 30 via a network 50. The system may also include one or more wireless base stations 61. The combined server 70 may include a symbol communication server 40 and a web server 60 to facilitate symbol based graphic communication. The symbol communication server 40 and the web server 60 will be described in detail below. In some embodiments the web server may be independent of the symbol communication server 40 or may not be a part of the system. In other embodiments, the independent web server can be communicatively coupled to the symbol communication server 40 via communication network (hereinafter network) 50, for example. In other embodiments, the client or user devices 20 and 30 may communicate with the symbol communication server 40 or each other via the wireless base station 61 and the network 50.

The symbol communication server 40, web server 60 and client devices 20 and 30 are configured with data storage areas, memory or storage devices 45, 65, 25 and 35 respectively. The data storage areas or memory 25, 35 45 and 65 can be any sort of internal or external memory device and may include both persistent and volatile memories. The function of the data storage area 45 is to maintain data (e.g., data relating to a business entity activities) for long term storage and also to provide efficient and fast access to instructions for applications that are executed by the symbol communication server 40. The symbol communication server 40 and the client devices 20 and 30 are all communicatively coupled with the network 50. In some embodiments the network 50 can be a wireless network. The network 50 is configured for data communications (e.g., between symbol communication server 40 and client device 20) over a wide geographical area and can be communicatively coupled with one or more public or private networks (not shown), which may include that particular aggregation of networks commonly known as the Internet.

The client or user devices 20 and 30 can also be implemented using a conventional computer device or other communication devices with the ability to connect to the network 50. The client devices 20 or 30 may be mobile or stationary units. The client devices 20 or 30 can include, for example, mobile stations, wireless communication device, mobile units, personal digital assistant (“PDA”), personal computer (“PC”), laptop computer, a wired or wireless telephone, wired or wireless email device, PC card, special purpose equipment, subscriber stations, wireless terminals, servers such as symbol communication servers, computers, personal media player, handheld devices or the like. The client device 20 or 30 may be, for example, a wireless handheld device, a vehicle mounted device, a portable device, client premise equipment, fixed location device, wireless plug-in accessory or the like or any combination of these and other devices capable of establishing a communication link over network 50 with the symbol communication server 40.

FIG. 2 is a block diagram illustrating an example symbol communication server 40 illustrated in FIG. 1 above according to an embodiment. The symbol communication server 40 is associated with a communication network 50. The symbol communication server is also configured to support the symbol communication language. In addition, the symbol communication server 40 includes a symbol control module or symbol module 90. In some embodiments, the symbol communication server 40 is coupled or configured with a data storage area or memory 45. The symbol communication server 40 is further configured to support a user interface module 95, such as a web page or website, over the communication network 50. The user interface module 95 can be configured to initiate an action associated with one or more symbol parameters where the one or more symbol parameters constitute at least a portion of the symbol communication language.

The one or more symbol parameters forming the symbol communication language can be shared among a group of users. Accordingly the symbol communication server 40 is configured to support multiple user defined symbol parameters forming customized symbol communication language. Each customized symbol communication language may be shared between a group of users such as friends, co-workers etc. The user interface module 95 may be configured to display the information related to the one or more symbol parameters. The one or more symbol parameters represent at least a portion of a textual representation for conveying a message according to the symbol communication language that visually engages users and enhance the users' communication.

In some embodiments, the one or more symbol parameters includes video, photos, icons, multimedia, data, embedded graphic, animated graphics interchange format, illustrations, links and a combination therein. The symbol parameters can be user-defined to form a customized symbol communication language that is unique to the user's personal interests, tastes and culture. These user defined symbol parameters and/or the textual representations associated with the symbol parameters can be stored in the memory 25 and/or 35 of the user devices 20 and/or 30 or may be stored in the memory 45 and/or 65 of the symbol communication server 40 and/or the web server 60. In other embodiments, pre-defined symbol parameters may be stored in the memory 45 for a user to use, share, download or adopt in the users symbol communication language or dictionary.

In general, the symbol control module 90 is associated with the symbol communication server and is configured to process information relating to the one or more symbol parameters according to the initiated action. The symbol control module 90 can be configured to process query's or requests from client device 20 or 30 and/or to receive and process symbol communications including new symbols or symbol parameters, editing existing symbols or symbol parameters, transmitting symbols or symbol parameters to client devices 20 or 30, storing symbols symbol parameters, associating symbols symbol parameters with text, textual representations or other symbol forms etc. A textual representation may include letters, numbers, alphanumeric representations, words, special characters, punctuations, sentences and the like or a combination therein.

The processing of information relating to the one or more symbol parameters according to the initiated action includes creating one or more symbol parameters, editing one or more symbol parameters, searching for one or more symbol parameters, rating one or more symbol parameters, exchanging one or more symbol parameters, storing one or more symbol parameters, selecting one or more previously created symbol parameters, generating a message based on one or more symbol parameters, posting a message related to the one or more symbol parameters on the user interface module 95, sending a message based on the symbol communication language, receiving a message based on the symbol communication language, converting one or more symbol parameters to the textual representation, converting the textual representation to one or more symbol parameters, defining a dictionary including one or more symbol parameters, wherein the dictionary represents symbol parameters and textual representation for communicating in a symbol communication language, adopting one or more symbol parameters defined by a different user and sharing one or more symbol parameters with at least one different user.

The message posted on the user interface module 95 may be accessible to other users. The message generated on the user interface module 95 may be sent or received at a user device 20 or 30 or may be displayed on the user interface module 95 for access by an authorized user. The users can be authorized access to the user interface module 95 by a shared access code such as a password or individual access codes. The action can be initiated automatically or by a user. The symbol control module is described in detail below.

A user can access a website supported by the web server 60 via the client device 20 and communicate with another client device or navigate the website hosted by the symbol communication server 40. The website may include an interactive workspace for sharing symbols relating to the symbols based graphic language. The shared symbols may be customized symbols that are generated for use by a set of users or standardized symbols accessible for use by all users. In one embodiment, if the author of the symbol is not a sender or a receiver of a message, then the symbol is passed only by reference and may be cached on both sender and receiver device 20, for example. The cached symbols can be tracked to ensure advertisers of the content they are distributing and the exposure/use. The website may include communication tools, a file structure, and project management tools used by the user and a server (coordinator), for example to facilitate receiving user generated symbols, processing the user generated symbols, and displaying the user generated symbol on the website.

In some embodiments the user generated symbols or symbol parameters have to undergo a filtering process to decide whether or not those symbols can be displayed on the website. The filter is determined by a relationship with the client website. An example could be to only translate terms they wish to be translated, ie ones that they have advertising contracts with. Another likely implementation will include packet transmission between the client devices and the website. These packets will further be translated to viewable source code by the website for the client device. This translation will occur seamlessly for the end user and will provide additional advertiser tracking metrics as well as keeping the client technology current at all times. This will also provide for context sensitive delivery of both the content and the style for all interpretations. Some examples could include location based advertising and coupon delivery for products or services that are being discussed in the client communication. It will also provide for a variety of other context interpretations, such as different content delivered depending on the familiarity of the receiving client to the sending client. These are just a couple of examples of the many contexts the system will provide for.

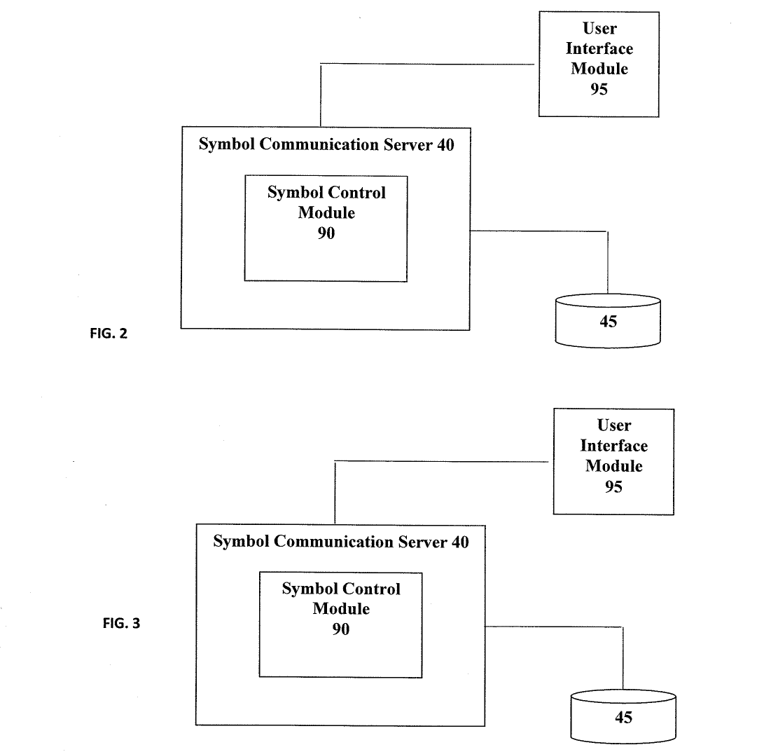

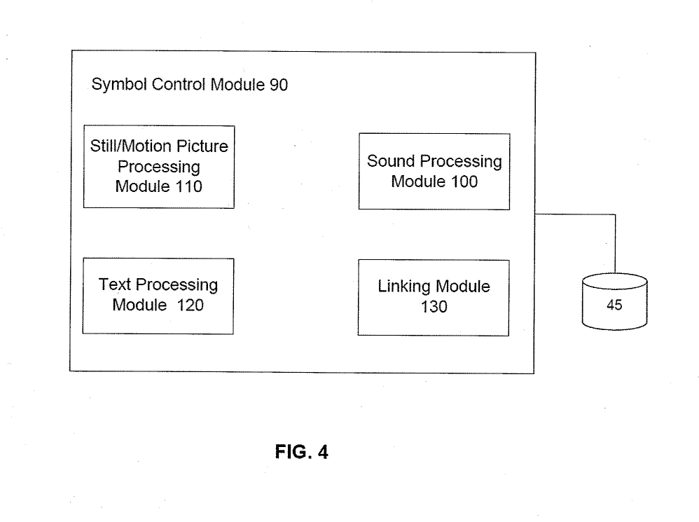

FIG. 3 is a block diagram illustrating an example web server 60 illustrated in FIG. 1 above according to an embodiment of the invention. The web server can be configured to function as a standard web server. For example, the web server 60 can be configured to accept hypertext transfer protocol (“HTTP”) requests from web clients (via a client device 20, for example), which are known as web browsers, and serving them HTTP responses along with optional data contents, which usually are web pages such as hypertext markup language (“HTML”) documents and linked objects (symbols including images, videos etc.). The web server 60 can also be coupled to or configured with a data storage area 65. In one embodiment, the web server 60 can be implemented as part of the symbol communication server 40 illustrated with respect to FIG. 2 above. In other embodiments the web server 60 may be independent of the symbol communication server 40, but communicatively coupled to the symbol communication server 40. The client device 20 and/or 30 can be coupled to the web server 60 via network 50. As a result a user of client device 20 or 30 can access content from the web server 60 or the symbol communication server 40, communicate with other client devices 20 or simply navigate content of the web server 60 or symbol communication server 40 via a web browser on the client device 20 or 30. In some embodiments the web browser can be utilized for sharing, uploading and downloading symbols. In other embodiments the symbol communication server 40 and the web server 60 can each be implemented as multiple servers.

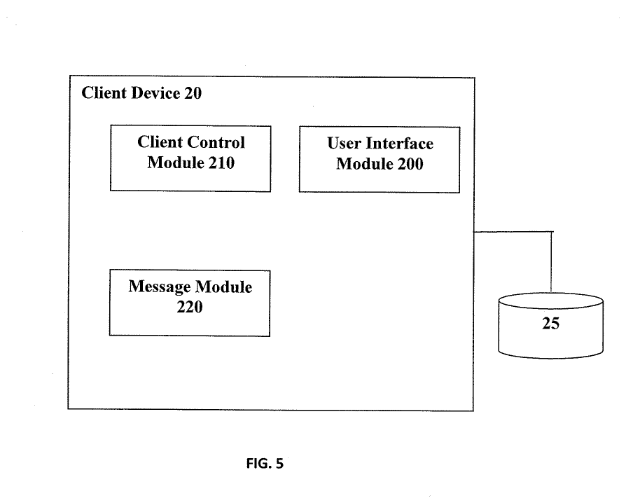

FIG. 4 is a block diagram illustrating an example symbol control module 90 according to an embodiment. For explanatory purpose the symbol control module 90 will be described with respect to FIGS. 1 and 2 above. The symbol control module 90 may be configured to receive information including queries or requests, predetermined symbols and/or user generated symbols from a client device 20 or a web browser associated with a client device 20. In one embodiment, the symbol communication server 40 may be configured to receive a text message or symbol, for example, from a client device 20 and convert or translate the text or symbol to a corresponding symbol or text or a combination of symbols and text. In some embodiments the symbols may include pictures, videos, text, sounds, uniform resource locator (“URL”), for example, or a combination thereof. Examples of the combination of pictures, videos/motion pictures, text, sounds and URL include still pictures or motion pictures embedded with sounds etc. In some embodiments, the symbol control module 90 may include a text processing module 100, a still/motion picture processing module 110, a sound processing module 120 and a linking module 130. One or more of the modules including the text processing module 100, a still/motion picture processing module 110, a sound processing module 120 and a linking module 130 may be independent of the symbol control module 90.

The sound processing module 120 may be configured to receive and process sounds associated with and/or representing the symbols. In some embodiments the symbols may be predetermined and stored in a storage area 45, described in FIG. 1, for retrieval by the symbol communication server 40 upon request. In other embodiments the symbol communication server 40 may comprise a user interface configured to receive user or administrator generated symbols. The linking module 130 may be coupled to the following: the text processing module 100, the sound processing module 120 and the still/motion picture processing module 110. The linking module 130 may be configured to associate or link predetermined symbols or user generated symbols with text and/or sounds associated with and/or representing the user generated or predetermined symbols, for example. The linking module 130 can link or associate any form of a symbol with any other form of symbol as a means of translating from one form to another or a means for providing other ways for representing the symbol or a text. Thus, for example, a text symbol may be linked or associated with a motion picture symbol for translation purposes.

In some embodiments the database 45 may be configured to store the predetermined symbols and user generated symbols. In other embodiments the symbols i.e. pictures, videos, text, sounds, URLs, for example, may be user generated or predetermined. The symbol communication server 40 may be configured to retrieve symbols from the database 45 and transmit the symbols to a client device 20, in response to a query or request received by the symbol communication server 40 from the client device 20. The query may include a request to convert text, for example a text message, a character or a string of characters to a symbol representing the text. The database 45 may include a set of symbols pre-associated with corresponding text or images, for example, representing the same word phrase or statement according to the symbol based graphic language. The set of symbols pre-associated with corresponding text or images may allow for faster translation of symbols. Although, in this embodiment, the symbol communication server 40 is shown as a single unit, it may include one or more computer systems.

FIG. 5 is a block diagram illustrating an example client or user device 20 according to an embodiment. For explanatory purpose the client device 20 will be described with respect to FIG. 1 above. The client device 20 may include a client control module or processor module 210, a user interface module or user device interface 200 a message module or communication module 220 and a database, memory or storage device 25. The user interface module or user device interface 200 may be configured to display the information received at the client device 20 or any information related to the one or more symbol parameters. The user interface module or user device interface 200 can be configured to initiate an action associated with one or more symbol parameters. The action can be initiated by the user or automatically. The one or more symbol parameters constitute at least a portion of the symbol communication language. In some embodiments, the user interface module or user device interface 200 is the same as the user interface module 95 of FIG. 2. In other embodiments, the user device is configured to access the user interface module 95 supported by a symbol communication server 40 or the web server 60 over the network 50. The processing of information relating to the one or more symbol parameters according to the initiated action includes creating one or more symbol parameters, storing one or more symbol parameters, selecting one or more previously created symbol parameters, generating a message based on one or more symbol parameters, converting one or more symbol parameters to the textual representation, converting the textual representation to one or more symbol parameters, defining a dictionary including one or more symbol parameters, wherein the dictionary represents symbol parameters and textual representation for communicating in a symbol communication language, adopting one or more symbol parameters defined by a different user and sharing one or more symbol parameters with at least one different user.

The client control module or processor module 210 is configured to process information relating to the one or more symbol parameters according to the initiated action. The processing of information relating to the one or more symbol parameters according to the initiated action include receiving information including queries or requests, predetermined symbols or symbol parameters and/or user generated symbols or symbol parameters from a user, another client device, the symbol communication server 40 or from a web browser supported by the web server 60 of FIG. 3 and/or the symbol communication server 40 of FIG. 2. In one embodiment, client control module 210 may be configured to receive a text message or symbol, for example, from the user, another client device or from a web browser and convert or translate the text or symbol to a corresponding symbol or text or a combination of symbols and text. In some embodiments symbols may be predetermined and stored in a storage area 25, described in FIG. 1, for retrieval by the client control module 210 upon request. The user interface module 200 may be configured to display the information received at the client device 20. The communication module 220 configured to communicate over a network to a symbol communication language enabled device such as a user device 20 or 30.

The client devices 20 and 30 can be configured to provide a platform for website interactive chat, instant message application, mobile phone messaging, emailing and more. In some embodiments the applications for the client device 20 or 30 are communicatively coupled to the symbol communication server 40 to allow new symbols to be received by the symbol communication server 40 and stored in a database 45, for example. The client device 20 or 30 can include mobile stations, one or more servers, wireless communication device, mobile units, personal digital assistant, personal computer, laptop computer, a wired or wireless telephone, wired or wireless email device, PC card, special purpose equipment, subscriber stations, wireless terminals, computers, personal media player and handheld devices. The client device 20 or 30 may also include one or more displays and speaker(s) for use in presenting content (e.g., audio and/or visual) to a user of the client device 20. Optionally, the client device 20 may also include a storage device 25 (e.g., volatile or non-volatile memory) for recording or storing the received data, symbol parameters or symbols. The client device 20 may include a user interface 210 configured to display user generated symbols and queries, for example. The client device 20 also includes a messaging interface (may be the same as the user interface module 200) configured to receive a message comprising symbols in preparation for transmission.

The symbols in the message can include pictures, videos, text, sounds, URL or a combination thereof. The symbols included in the message may be generated by the user or retrieved from a storage device 25, for example a database, associated with the client device 20, or retrieved from a symbol communication server 40, for example. In some embodiments the user generated symbols may be incorporated into a set of standard symbols that are stored in a database 45, for example, for sharing with other users. In other embodiments, the user generated symbols may be customized and stored either locally in storage device 25 or in database 45. The local storage device 25 may include a local library of symbols that are unique to the user (customized) and a cache or temporary storage of symbols. The cache or temporary storage of symbols may be associated with the client device of at least a second user that the user communicates with. In some embodiments, the cache or temporary storage of symbols may be associated with symbols of other users received or downloaded from the symbol communication server 40. The messaging interface can also be configured to receive messages at the client device 20. The client device 20 and the symbol communication server 40 can allow for different applications of the technology. For example, a user may engage in website interactive chat, like the old bulletin board systems, an instant messaging application for various operating systems used in, for example desktops and mobile phones, and email plugins.

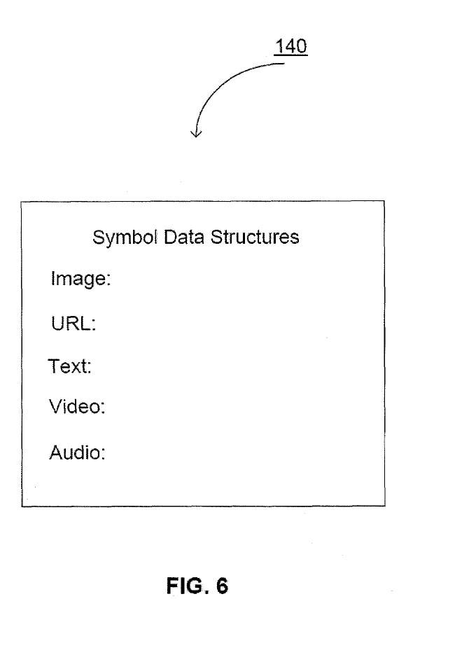

FIG. 6 illustrates an example symbol data structure 140 according to an embodiment. Advantageously, all information relating to a single symbol can be represented in a symbol data structure 140. The symbol data structure 140 is a collection of fields and/or data items that together represent a symbol. In this embodiment the fields of the data structure include an image field, URL field, a text field, a video field and an audio field. This representation of a symbol in the symbol data structure format allows the symbols to be easily presented to a user in a single compact data structure and to easily convert or interpret a symbol. For example, a symbol represented as an image can be easily converted to a text format and vice versa by reference to the various fields of the data structure. The symbol data structures may be stored in a file. In other embodiments the symbols can be represented in other structural forms, for example file structure or a combination of multiple structural formats. Much of the variations in which the symbols are represented is determined by the author of the Symb. Authoring of a Symb can be done on a website supported by the symbol communication server 40.

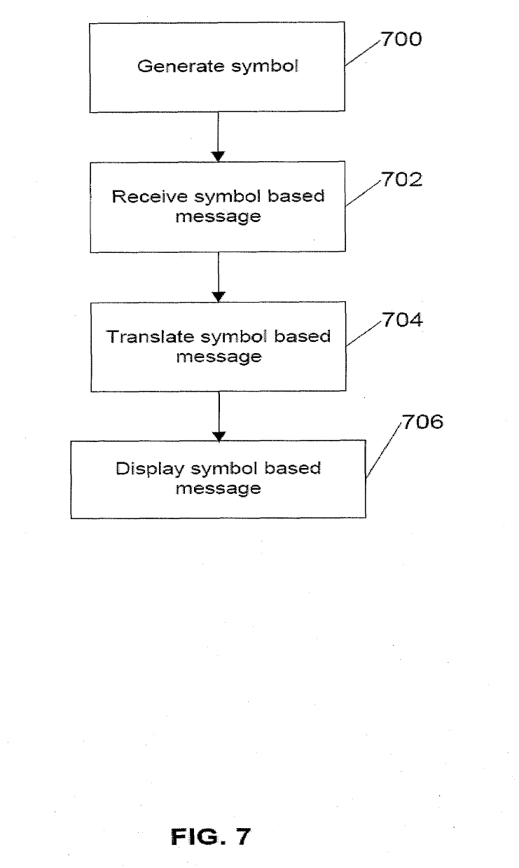

FIG. 7 is a flowchart of an example method for processing symbol based graphic communication according to an embodiment. In step 700, a symbol is generated and stored in a storage device. For example the storage device can be the storage device 25, 35, 45 or 65 described with respect to FIG. 1 above. The process then continues to step 702 where a symbol based message, query or request is received at the client device 20. The symbol based message, query or request can be received from a different client device 30. In step 704, the symbol communication message is displayed on the client device 20. In some embodiments the symbol communication message can be translated to a text, sound or http, for example. In other embodiments new symbols can be added to the to the storage devices 25, 35, 45 or 65. In other embodiments the symbols can be predetermined and stored in a storage area 45.

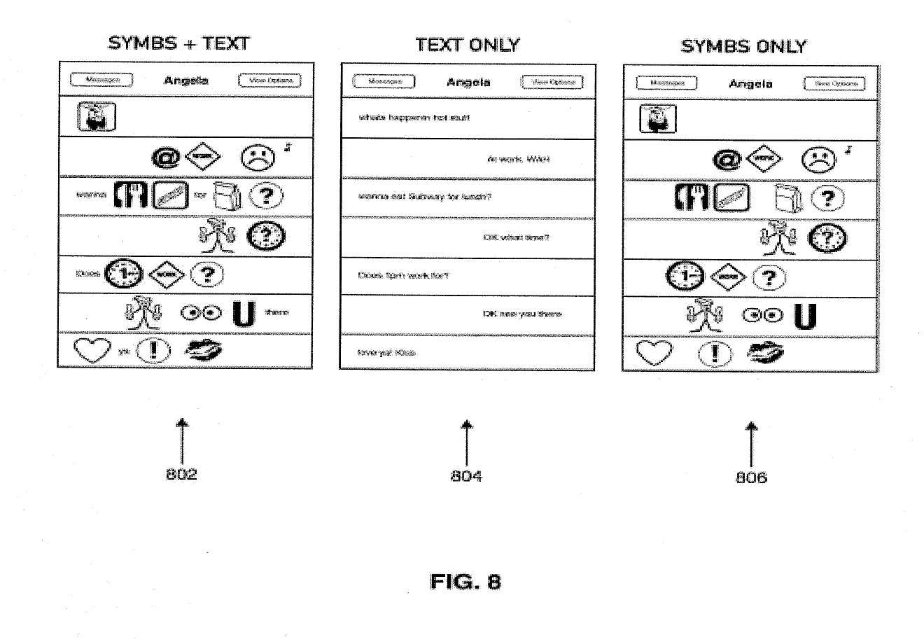

FIG. 8 illustrates an example messaging interface according to an embodiment. In interface 802 the message includes a set of symbol elements or symbols that are a combination of pictures and text, while interface 804 represents a text message and interface 806 represents a set of symbol elements represented by pictures. The messaging interface may have a view options menu from which predetermined symbols can be selected for use in the message, for example. Each symbol element of the message can be represented in different forms. For example the term “work” can be represented by a sign as illustrated in FIGS. 8A and 8C. Other elements of a message can be represented in other forms including text, picture, video, sound, location, contact info, author, and more or a combination of the different forms. In some embodiments the symbol elements may be embedded with other symbol elements, for example, a map of a location, a voice call, web URL, text, picture, video, sound, location, contact info, author etc. The embedded information may be accessed automatically or by clicking on a symbol element, for example. The storage device 25 can be configured to store at least some of the user generated symbols and/or at least some of the predetermined symbols. The predetermined symbols may be received from the symbol communication server 40 or preinstalled in the client device 20. The user generated symbols can be configured for editing by other users, for example, or locked to prevent editing.

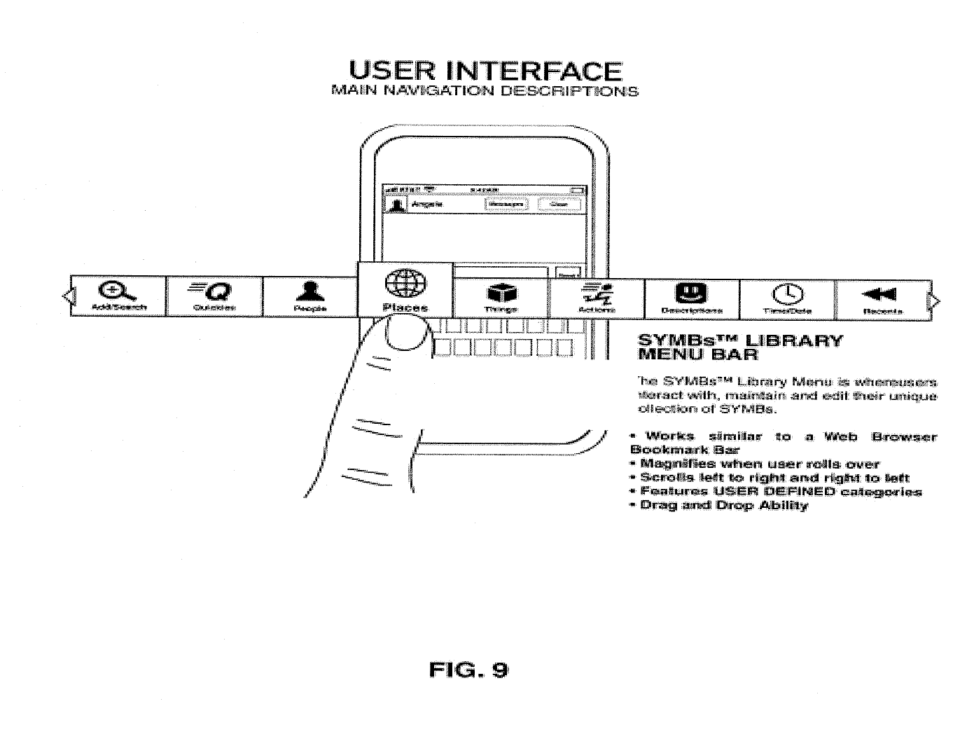

FIG. 9 is a screen shot of an example user interface illustrating a symbol library menu according to an embodiment. The symbol library menu may be implemented on the user interface of a client device 20. The symbol library menu may also be implemented on an interactive workspace on a website supported by web server 60 of FIG. 1 above. A user can utilize the symbol library menu to interact with, maintain and edit the user's collection of symbols. In one embodiment, selections on the symbol library menu are magnified as the user selects or scrolls over a selection.

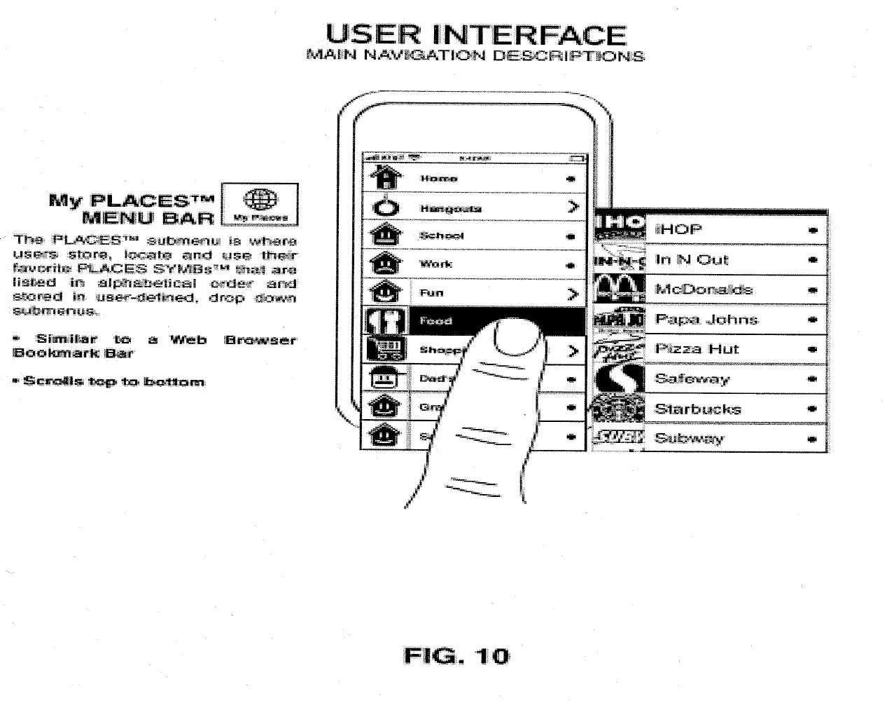

FIG. 10 is a screen shot of an example user interface illustrating a menu of locations or places frequented by the user according to an embodiment. The menu of locations may be implemented on the user interface of client device 20 illustrated in FIG. 1 above. In one embodiment, the menu of locations is where the user can store, locate and use the symbols representing the user's favorite places. The symbols may be listed in alphabetical order and stored in a user-defined drop down sub-menu.

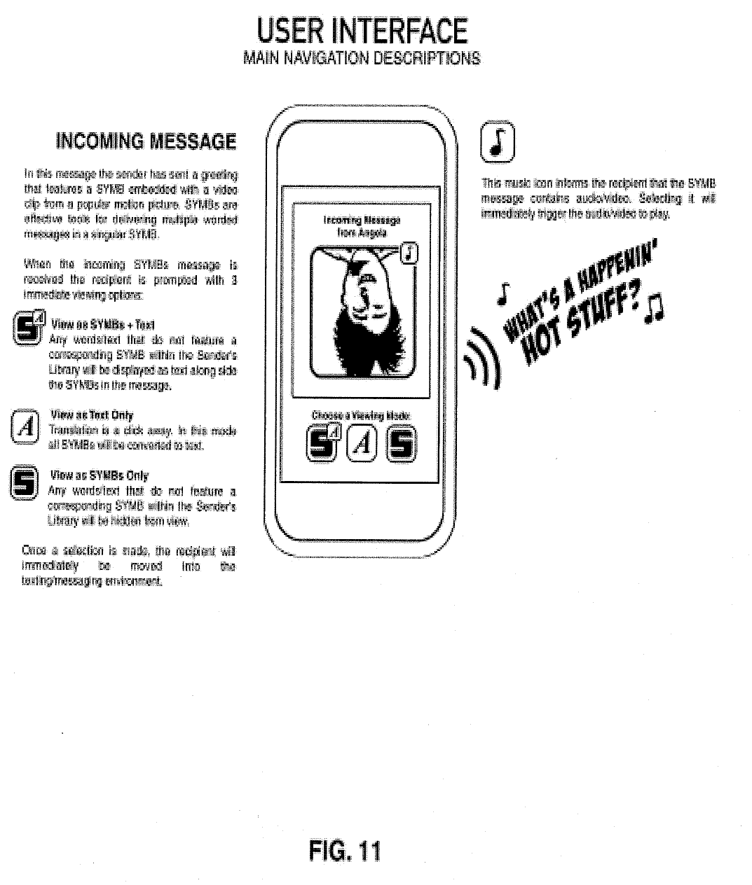

FIG. 11 is a screen shot of an example user interface illustrating a messaging interface according to an embodiment. The messaging interface may be implemented on the client device 20. In this embodiment, the messaging interface displays a greeting message that features a symbol embedded with a video clip from a motion picture. Thus multiple worded messages can be delivered in a singular symbol. In one embodiment the recipient of a symbol message may be afforded a plurality of selectable viewing options or formats. The recipient may be prompted to select a viewing option or format upon receipt of the symbol message. Some examples of viewing options or formats include a symbol and text view, a text only view and a symbol only view. The client device 20 may include a controller module configured to receive a message in one format (e.g. text, video, pictures etc) and converting the message to a different format. Thus the controller module can translate messages from one format to another. For example, the controller module can translate a symbol message to a text message and vice versa.

In one embodiment, the conversion of messages from one format to another is based on whether or not an element of the message in one format has corresponding element in another format. For example, a word or text that does not feature a corresponding symbol within the sender's symbol library will be displayed as text alongside symbols in the message. In some embodiments the linking module of the symbol communication server can perform the functions of the controller module. In some embodiments the word or text may be hidden when viewing from a symbols only view interface. In one embodiment an icon may be displayed on the messaging interface to indicate that a message in one format is embedded with information in another format. For example, a music icon informs the recipient that the symbol message contains audio/video and selecting the icon may trigger the audio/video to play.

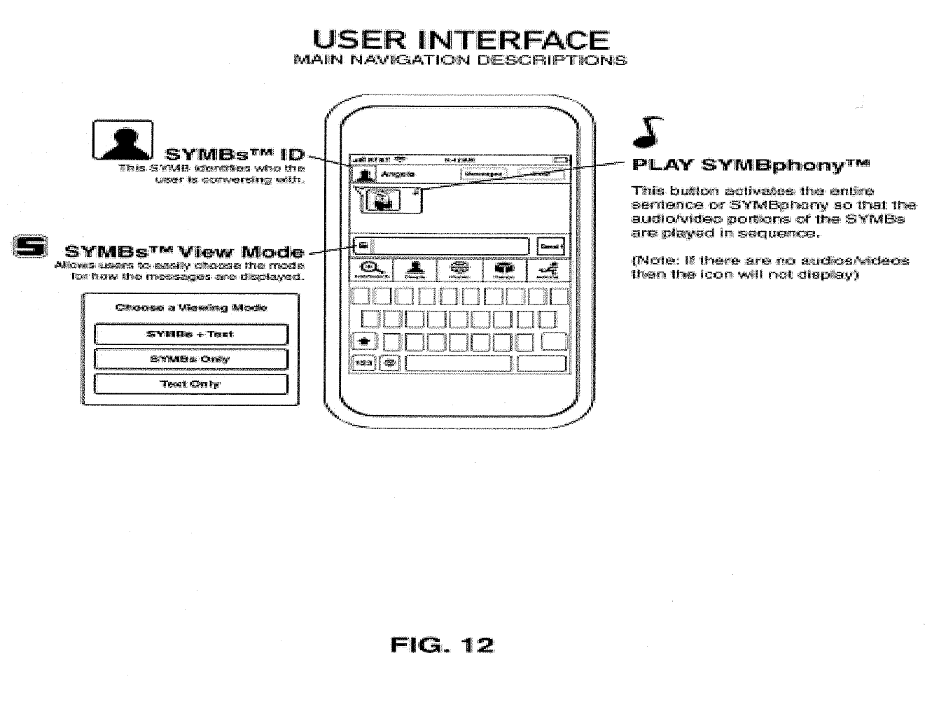

FIG. 12 is a screen shot of another example messaging interface according to an embodiment. The messaging interface may be implemented on the client device 20. In this embodiment, the messaging interface can display a greeting message that features a symbol embedded with a video clip from a motion picture. The messaging interface may be configured to identify the party the user is conversing with. The identification may be in the form of a picture or a name or both. The messaging interface may also include a selectable option that allows users to easily select the format or mode for displaying the message. An icon, for example a music icon, may be configured to activate the entire message so that the audio/video portions, for example, are played in sequence.

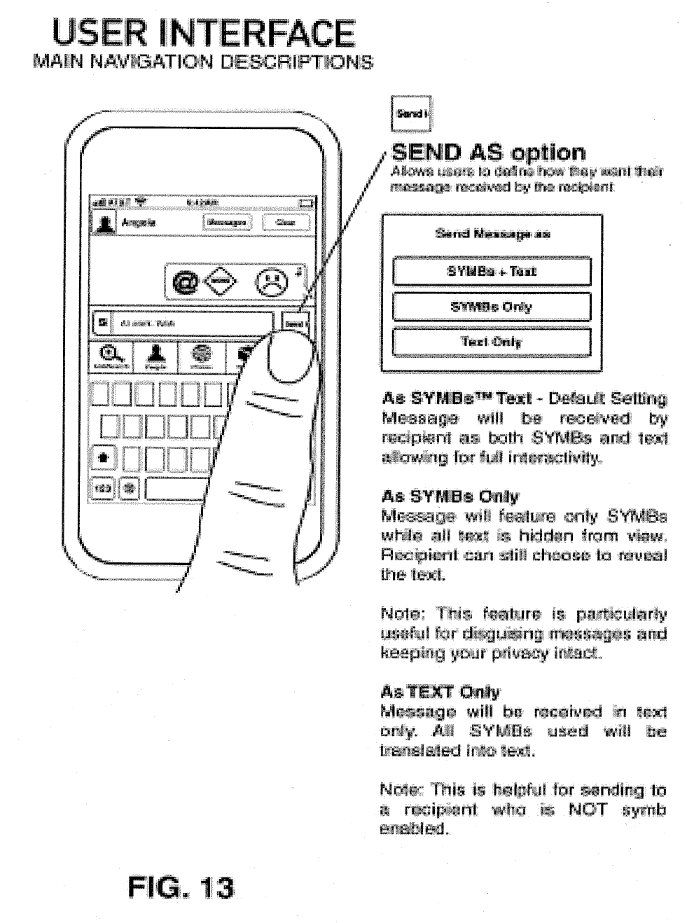

FIG. 13 is a screen shot of another example messaging interface including a send option according to an embodiment. The messaging interface may be implemented on the client device 20. In this embodiment, the messaging interface displays a user generated symbol message that features a symbol embedded with video/audio. The messaging interface comprises a send icon that allows the user to select the format the message is received by the recipient. In one embodiment the user can select a text only format, a symbol only format or a combination of a symbol and text format. In the text only format the message will be received in text and all symbols will be translated to text. This feature may be useful for recipients who are not proficient with the communicating in symbols or client devices that are not enabled to communicate in symbols. In the text and symbols format the message will be received in both symbols and text allowing for full interactivity. In the symbols only format the message will feature only symbols while all text will be hidden from view. This feature may be particularly useful for disguising the message and for maintaining some degree of privacy. However in some embodiments the recipient can choose to reveal the text.

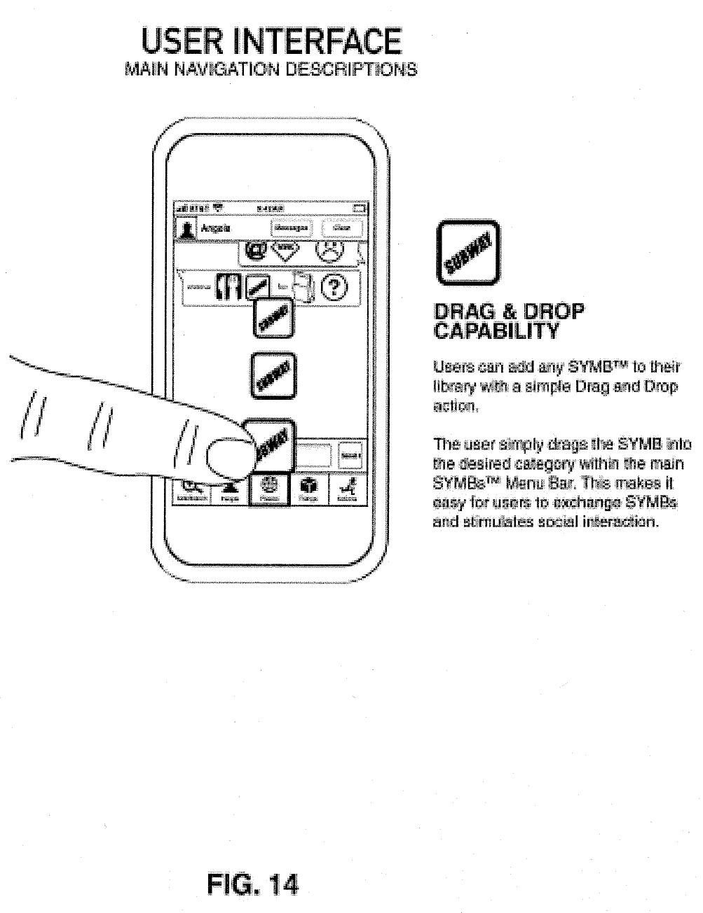

FIG. 14 is a screen shot of another example messaging interface drag and drop function according to an embodiment. The messaging interface may be implemented on the client device 20. In this embodiment, the messaging interface displays a symbol message that features multiple symbols. The symbols in the message may be received by a sender or inputted in the client device 20 via scanning process. In the event a symbol in the message is not available in the symbol the messaging interface allows for dragging and dropping the symbol into a desired category within the main symbols menu bar displayed on the messaging interface. This feature allows users to exchange symbols and simulate social interaction.

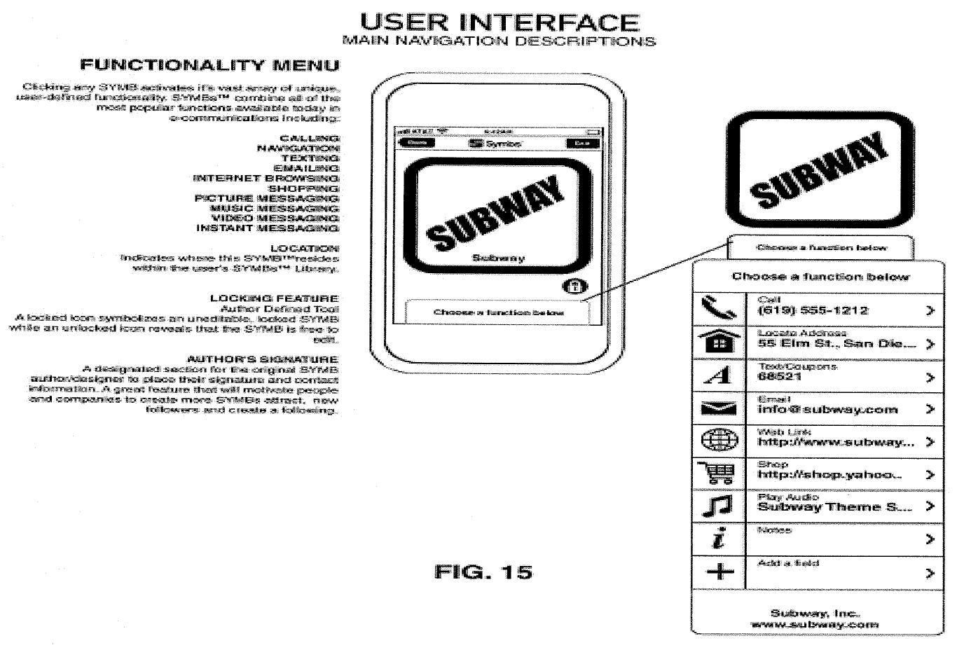

FIG. 15 is a screen shot of an example user interface illustrating a functionality menu according to an embodiment. The user interface may be implemented on the client device 20. A user can define a vast array of functionality associated with a symbol. For example, if a user selects or clicks on a symbol, the vast array of user defined functionality can be activated. The vast array of functionality may be a combination of functions available in e-communications including calling, navigation, texting, emailing, internet browsing, shopping, picture messaging, music messaging, video messaging, instant messaging. Other features include a location feature which indicates where the symbol resides within the user's symbol library. In one embodiment the user interface displays a user defined icon, for example a locked icon that symbolizes an uneditable symbol, while an unlocked icon indicates that the symbol can be edited. In one embodiment, the functionality includes a designated section for the original author/designer of the symbol to place their identification information, for example, their signature and contact information.

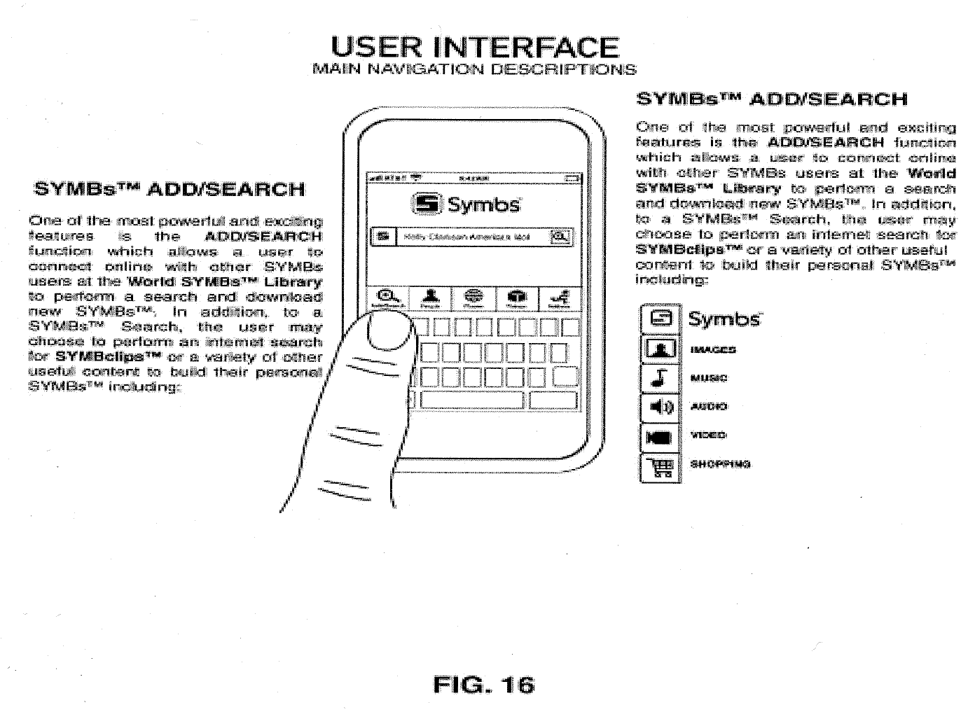

FIG. 16 is a screen shot of an example user interface illustrating search functionality according to an embodiment. The user interface may be implemented on the client device 20. Search functionality, for example add/search function may be displayed on the user interface and allows a user to communicate over a network, for example the internet, to the symbol communication server 40. The user may access the symbol library at the symbol communication server 40, or connect with other users by a connection established through the add/search function. In one embodiment the user can access the symbol library of another user via the add/search function. The add/search feature may also allow the user to search a symbol library and download new symbols. In addition the add/search function may allow the user to search for and download from the internet, symbols or a variety of other useful content associated with the symbols, for example, images, music, audio, video and shopping information.

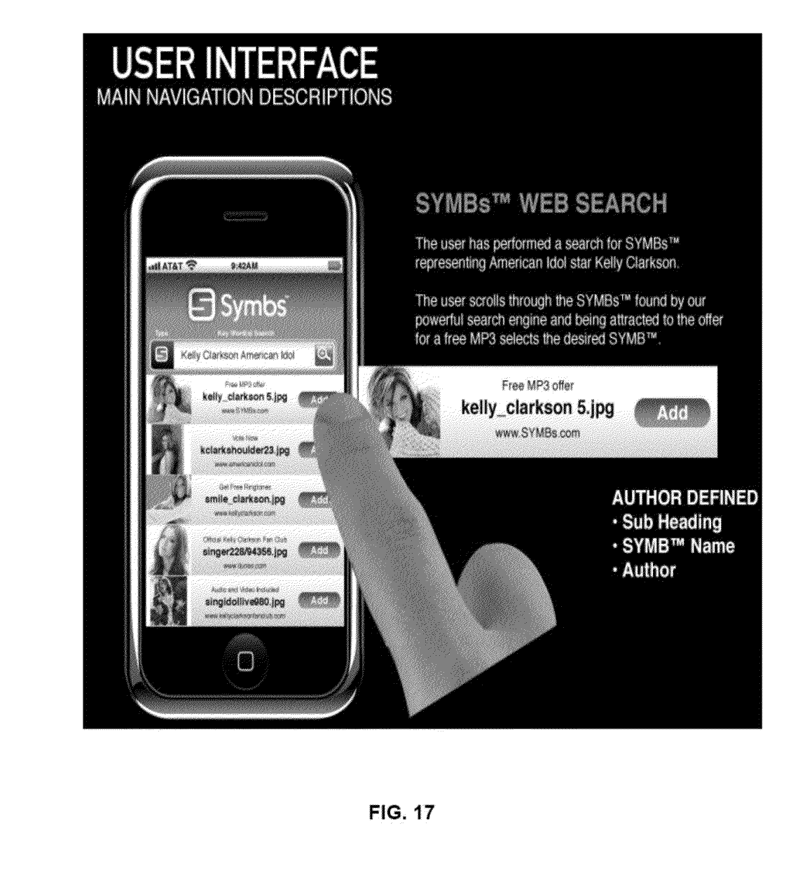

FIG. 17 is a screen shot of an example user interface displaying a symbol search response according to an embodiment. The user interface may be implemented on the client device 20 illustrated in FIG. 1 above. In this embodiment, a user searched using the search functionality for symbols relating to American Idol Kelly Clarkson. In response the user receives several symbols acquired by the search functionality and selects the desired symbol. The user can subsequently save the symbol in a local library or use the symbol in a symbol message, for example.

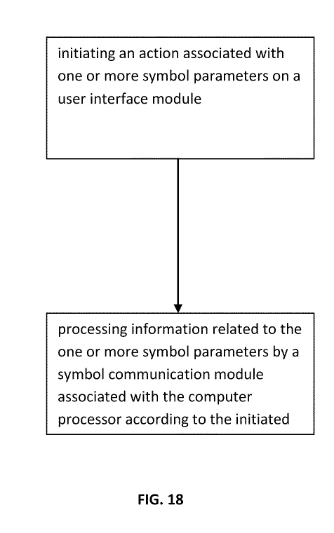

FIG. 18 is an example of a method for communicating in a symbol based communication system in accordance with an embodiment. The steps of this process may be implemented in the symbol communication system of FIG. 1. At step 900 the process starts with initiating an action associated with one or more symbol parameters on a user interface module 95 and/or user interface module 200. The user interface module 200 is associated with a computer processor or client control module 210 or symbol control module 90. The process then continues to step 902 where information related to the one or more symbol parameters are processed by the symbol communication module 90 associated with the computer processor according to the initiated action.

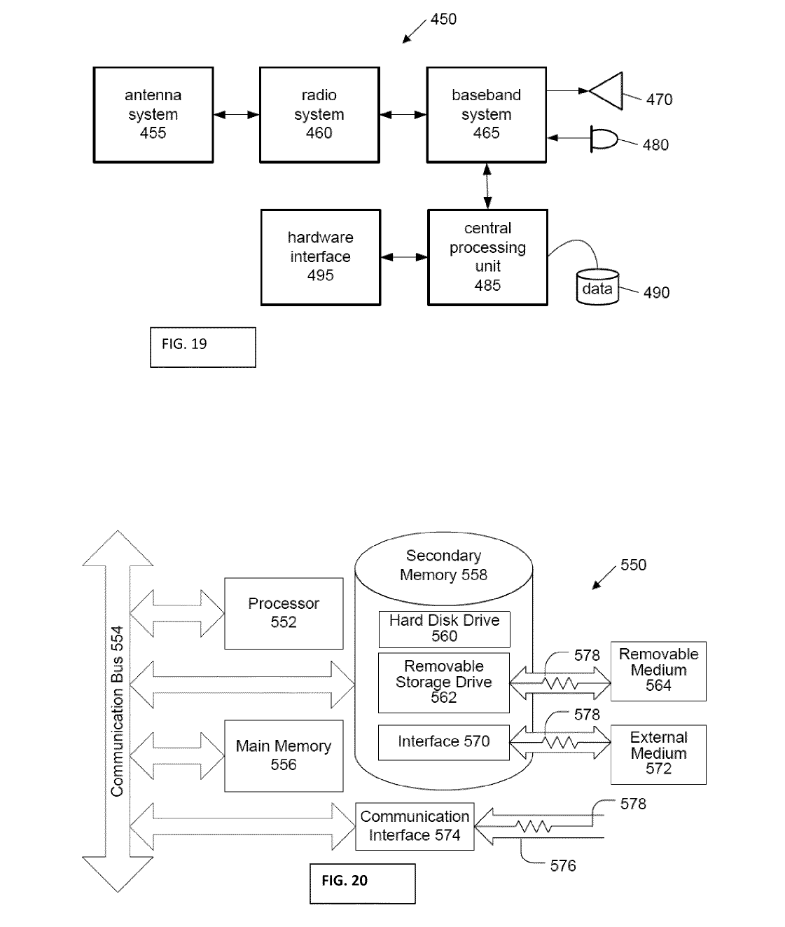

FIG. 19 is a step diagram illustrating an example wireless communication device 450 that may be used in connection with various embodiments described herein. For example, the wireless communication device 450 may be similar or the same as the client devices 20 and 30 illustrated in FIG. 1 above. However, other wireless communication devices and/or architectures may also be used, as will be clear to those skilled in the art.

In the illustrated embodiment, wireless communication device 450 comprises an antenna system 455, a radio system 460, a baseband system 465, a speaker 464, a microphone 470, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured to communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) that were previously described with respect to FIGS. 1-5.

In this description, the term “computer readable medium” is used to refer to any media used to provide executable instructions (e.g., software and computer programs) to the wireless communication device 450 for execution by the central processing unit 485. Examples of these media include the data storage area 490, microphone 470 (via the baseband system 465), antenna system 455 (also via the baseband system 465), and hardware interface 495. These computer readable mediums are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

FIG. 20 is a step diagram illustrating an example computer system 550 that may be used in connection with various embodiments described herein. For example, the computer system 550 may be used in conjunction with the client device 20 or 30, and/or the symbol communication server 40 and/or web server 60 previously described with respect to FIG. 1. Other computer systems and/or architectures may also be used as will be understood by those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (RF) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage medium 564, and external storage medium 572), and any peripheral device communicatively coupled with communication interface 574 (including a network information server or other network device). These computer readable mediums are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A symbol based graphic communication system comprising:
a symbol communication server associated with a communication network, the symbol communication server configured to support a symbol communication language;
a user interface module supported by the symbol communication server, the user interface module for initiating an action associated with one or more symbol parameters, the one or more symbol parameters constitute at least a portion of the symbol communication language; and
a symbol module associated with the symbol communication server, the symbol module configured to process information relating to the one or more symbol parameters according to the initiated action.

2. The symbol based graphic communication system of claim 1, wherein the user interface module is a website.

3. The symbol based graphic communication system of claim 1, wherein the action is initiated automatically.

4. The symbol based graphic communication system of claim 1, wherein the action is initiated by a user.

5. The symbol based graphic communication system of claim 1, wherein the action is selected from the group of actions consisting of
creating one or more symbol parameters,
storing one or more symbol parameters,
selecting one or more previously created symbol parameters,
generating a message based on one or more symbol parameters,
collecting one or more symbol parameters,
editing one or more symbol parameters,
searching for one or more symbol parameters,
rating one or more symbol parameters,
exchanging one or more symbol parameters,
posting a message related to the one or more symbol parameters on the user interface module,
sending a message based on the symbol communication language,
receiving a message based on the symbol communication language,
converting one or more symbol parameters to the textual representation,
converting the textual representation to one or more symbol parameters,
defining a dictionary including one or more symbol parameters, wherein the dictionary represents symbol parameters and textual representation for communicating in a symbol communication language,
adopting one or more symbol parameters defined by a different user, and
sharing one or more symbol parameters with at least one different user.

6. The symbol based graphic communication system of claim 1, wherein the one or more symbol parameters represent at least a portion of a textual representation for conveying a message according to the symbol communication language.

7. The symbol based graphic communication system of claim 1, further comprising a memory associated with the server for storing the one or more symbol parameters.

8. The symbol based graphic communication system of claim 7, further comprising at least one pre-defined set of symbol parameters stored in the memory.

9. The symbol based graphic communication system of claim 1, further comprising a memory associated with the server for storing textual representation associated with the one or more symbol parameters.

10. The symbol based graphic communication system of claim 1, wherein the one or more symbol parameters is selected from the group of symbol parameters consisting of video, photos, icons, multimedia, data, embedded graphic, animated graphics interchange format, illustrations, links and a combination therein.

11. The symbol based graphic communication system of claim 1, wherein the one or more symbol parameters are user defined.

12. The symbol based graphic communication system of claim 11, wherein the one or more user defined symbol parameters are customizable to form a user's personal symbol communication language that are unique to the user's personal interests, tastes and culture.

13. A user device for communicating in a symbol communication language comprising:
a user device interface for initiating an action associated with one or more symbol parameters, the one or more symbol parameters constitute at least a portion of the symbol communication language;
a processor module configured to process information relating to the one or more symbol parameters according to the initiated action; and
a communication module configured to communicate over a network to a symbol communication language enabled device.

14. The user device of claim 13, further comprising a user device memory configured to store the one or more symbol parameters.

15. The user device of claim 13, wherein the symbol communication language enabled device is selected from the group consisting of mobile stations, server, wireless communication device, mobile units, personal digital assistant, personal computer, laptop computer, a wired or wireless telephone, wired or wireless email device, PC card, special purpose equipment, subscriber stations, wireless terminals, computers, personal media player, handheld devices.

16. The user device of claim 13, wherein the user device is configured to access a user interface module supported by a symbol communication server over the network, wherein the symbol communication server is a server enabled for symbol communication language.

17. The user device of claim 16, wherein the symbol communication server is associated with a server memory for storing one or more symbol parameters.

18. The user device of claim 13, wherein the action is selected from the group of actions consisting of
creating one or more symbol parameters,
storing one or more symbol parameters the user device memory,
storing the one or more symbol parameters in the server memory,
selecting one or more previously created symbol parameters,
sending a message based on the symbol communication language,
receiving a message based on the symbol communication language,
generating a message based on one or more symbol parameters,
converting one or more symbol parameters to the textual representation,
converting the textual representation to one or more symbol parameters,
defining a dictionary including one or more symbol parameters, wherein the dictionary represents symbol parameters and textual representation for communicating in a symbol communication language,
adopting one or more symbol parameters defined by a different user, and
sharing one or more symbol parameters with at least one different user.

19. The user device of claim 13, wherein the one or more symbol parameters represent at least a portion of a textual representation for conveying a message according to the symbol communication language.

20. The user device of claim 14, wherein the user device memory is further configured to store textual representation associated with the one or more symbol parameters.

21. The user device of claim 13, wherein the one or more symbol parameters is selected from the group consisting of video, photos, icons, multimedia, data, embedded graphic, animated graphics interchange format, illustrations, links and a combination therein.

22. The user device of claim 13, wherein the one or more symbol parameters are user defined.

23. The user device of claim 22, wherein the one or more user defined symbol parameters are customizable to form a user's personal symbol communication language that are unique to the user's personal interests, tastes and culture.

24. The user device of claim 13, wherein the one or more symbol parameters define at least a portion of a textual representation to visually engage users and enhance the users' communication.

25. A method for communicating in a symbol based graphic communication system comprising:
initiating an action associated with one or more symbol parameters on a user interface module, the user interface module associated with a computer processor, the computer processor associated with a communication network, the one or more symbol parameters constitute at least a portion of the symbol communication language; and
processing information related to the one or more symbol parameters by a symbol communication module associated with the computer processor according to the initiated action.

26. The method of claim 25, wherein computer processor is a symbol communication server and the user interface module is supported by the symbol communication server, wherein the symbol communication server is configured to support communication in the symbol communication language.

27. The method of claim 25, wherein the computer processor is a processor associated with a user device.

28. The method of claim 25, wherein the one or more symbol parameters represent at least a portion of a textual representation for conveying a message according to the symbol communication language.

29. The method of claim 25, wherein the action is selected from the group of actions consisting of
creating one or more symbol parameters,
storing one or more symbol parameters,
selecting one or more previously created symbol parameters,
generating a message based on one or more symbol parameters,
posting a message related to the one or more symbol parameters on the user interface module,
sending a message based on the symbol communication language,
receiving a message based on the symbol communication language,
converting one or more symbol parameters to the textual representation,
converting the textual representation to one or more symbol parameters,
defining a dictionary including one or more symbol parameters, wherein the dictionary represents symbol parameters and textual representation for communicating in a symbol communication language,
adopting one or more symbol parameters defined by a different user, and
sharing one or more symbol parameters with at least one different user.

30. The method of claim 25, wherein the one or more symbol parameters is selected from the group consisting of video, photos, icons, multimedia, data, embedded graphic, animated graphics interchange format, illustrations, links and a combination therein.
